(19) United States
(12) Patent Application Publication
(10) Pub. No.: US 2019/0262877 A1
(43) Pub. Date: Aug. 29, 2019

(54) Situ Ferrate Generation

(71) Applicants: James Mueller, Freeport, IL (US); Dennis Grubb, Lansdale, PA (US); Michael Scalzi, Doylestown, PA (US); Antonis Karachalios, Hatfield, PA (US)

(72) Inventors: James Mueller, Freeport, IL (US); Dennis Grubb, Lansdale, PA (US); Michael Scalzi, Doylestown, PA (US); Antonis Karachalios, Hatfield, PA (US)

(21) Appl. No.: 16/299,007

(22) Filed: Mar. 11, 2019

Related U.S. Application Data
(63) Continuation-in-part of application No. 15/250,907, filed on Aug. 29, 2016.
Application No. 15/250,907 is a continuation-in-part of application No. 14/268,629, filed on May 2, 2014, now Pat. No. 9,427,786.
Application No. 14/268,629 is a continuation-in-part of application No. 13/891,934, filed on May 10, 2013, now Pat. No. 9,126,245.
(60) Provisional application No. 62/641,074, filed on Mar. 9, 2018.

(51) Int. Cl. B09C 1/08; C02F 1/72

(52) U.S. Cl. CPC B09C 1/08; C02F 2101/322; B09C 2101/00; C02F 1/72

(57) ABSTRACT

Chemically oxidizing a wide range of targeted contaminants in soils, sludges, and groundwater and assisting in the eventual (over time) biological attenuation of the contaminants utilizing persulfates activated by BOF steel slag and iron species, such as ferric iron. The use of BOF steel slag and iron species to activate persulfate results in a formation of persulfate-based reactive species and ferrate (pH stabilized) for multiple chemical oxidation processes that rapidly degrade target contaminants. Furthermore, residual iron sulfate supports biodegradation of partially oxidized compounds.

### BACKGROUND

Chlorinated solvents and petroleum hydrocarbons, including polyaromatic hydrocarbons are compounds characterized by their toxicity to organisms at higher concentrations and are widely distributed in oil contaminated soils and groundwater.

Halogenated volatile organic compounds (VOCs), including chlorinated aliphatic hydrocarbons (CAHs), are the most frequently occurring type of contaminant in soil and groundwater at Superfund and other hazardous waste sites in the United States. The U.S. Environmental Protection Agency (EPA) estimates that cleanup of these sites will cost more than $45 billion (1996) over the next several decades.

CAHs are manmade organic compounds. They typically are manufactured from naturally occurring hydrocarbon constituents (methane, ethane, and ethene) and chlorine through various processes that substitute one or more hydrogen atoms with a chlorine atom, or selectively remove chlorine atoms from fully chlorinated hydrocarbons. CAHs are used in a wide variety of applications, including uses as solvents and degreasers and in the manufacturing of raw materials. CAHs include solvents such as tetrachloroethene (PCE), trichloroethene (TCE), carbon tetrachloride (CT), chloroform (CF), and methylene chloride (MC). Historical management of wastes containing CAHs has resulted in contamination of soil and groundwater, with CAHs present at many contaminated groundwater sites in the United States. TCE is among the most prevalent of those contaminants. In addition, CAHs and their degradation products, including dichloroethane (DCA), dichloroethene (DCE), and vinyl chloride (VC), tend to persist in the subsurface for long periods creating a hazard to public health and the environment. Other halogenated compounds include chlorinated pesticides, polychlorinated biphenyls (PCBs) and fluorinated compounds such as Freon, perfluorooctanesulfonic acid (PFOS) and perfluorooctanoic acid (PFOA).

Benzene, toluene, ethylbenzene, and xylenes (BTEX) are characterized by their toxicity to organisms at higher concentrations, and are widely distributed in oil contaminated soils, groundwater, and sediments as a result of their relatively high aqueous solubility compared to other components of petroleum. The United States Environmental Protection Agency (U.S. EPA) estimates, 35% of the U.S.'s gasoline and diesel fuel underground storage tanks (USTs) are leaking and approximately 40% of these leaking USTs likely have resulted in soil and groundwater contaminations from BTEX. BTEX are volatile and water-soluble constituents that comprise 50% of the water-soluble fraction of gasoline. The presence of BTEX in groundwater can create a hazard to public health and the environment.

BTEX compounds are readily degradable in aerobic surface water and soil systems; however, in the subsurface environment, contamination by organic compounds often results in the complete consumption of available oxygen by indigenous microorganisms and the development of anaerobic conditions. In the absence of oxygen, biodegradation of BTEX can take place only with the use of alternative electron acceptors, such as nitrate, sulfate, or ferric iron, or fermentatively in combination with methanogenesis. Anaerobic biodegradation of BTEX is much slower than aerobic processes.

PCBs are organochlorine compounds which are mixtures of up to 209 individual chlorinated compounds referred to as congeners. These congener mixtures of chlorobiphenyl (the base chemical) are referred to by different identification systems. PCBs have been commercially produced and sold as pure oil or in equivalent form since around 1929. They are extremely stable compounds with excellent electrical insulation and heat transfer properties. These characteristics have led to their widespread use in a variety of industrial, commercial and domestic applications. These same properties have rendered them extremely resistant to degradation.

PCBs can be released to the environment in various manners, including but not limited to, from hazardous waste sites; illegal or improper disposal of industrial wastes and consumer products; leaks from old electrical transformers containing PCBs; and incinerating some wastes. Their major disadvantage is that they do not readily break down in the environment and thus may remain stable for very long periods of time. PCBs can travel long distances in the air and be deposited in areas far away from where they were released.

While water contamination can occur, many PCBs slowly dissolve or absorb to sediments or attach themselves to organic particles. Similarly, PCBs can be easily attached to soil particles. They can also be absorbed by small organisms and fish and through the food chain can travel to other animals. PCBs bioaccumulate in fish and marine mammals, reaching levels that may be many thousands of times higher than in water.

The U.S. EPA has established permissible levels for chemical contaminants in drinking water supplied by public water systems. These levels are called Maximum Contaminant Levels (MCLs). To derive these MCLs, the U.S. EPA uses a number of conservative assumptions, thereby ensuring adequate protection of the public. In the case of known or suspected carcinogens, such as benzene or PCE, the MCE is calculated based on assumption that the average adult weighs 154 lbs. and consumes approximately 2 quarts of water per day over a lifetime (70 years). The MCE is set so that a lifetime exposure to the contaminant at the MCE concentration would result in no more than 1 to 100 (depending on the chemical) excess cases of cancer per million people exposed. FIG. 1 is a table that outlines the MCE values for various chemicals.

Chemical oxidation is one technology utilized to treat organic contaminants in soils and groundwater. Oxidants utilized in remediation include hydrogen peroxide (H₂O₂). Persulfates (S₂O₈) are strong oxidants that have been widely used in many industries for initiating emulsion polymerization reactions, clarifying swimming pools, hair bleaching, micro-etching of copper printed circuit boards, and total organic compound (TOC) analysis. There has been increasing interest in persulfates serving as an oxidant for the destruction of a broad range of soil and groundwater contaminants. Persulfates are typically manufactured as sodium, potassium, and ammonium salts. Sodium persulfate (Na₂S₂O₈) is the most commonly used for environmental applications. The persulfate anion is the most powerful oxidant of the peroxygen family of compounds and one of the strongest oxidants used in remediation.

The activation of the persulfate can be accomplished using various metals (e.g., iron, manganese, palladium, zinc) in all valence states, ultra violet (UV) light, heat, carbonate, elevated pH, and liquid (hydrogen) peroxide. Each of these activation technologies targets a specific organic range of contaminants. The use of chelated divalent metal complexes to activate persulfate expands the range of contaminants targeted but prevents biological remediation which is a critical step in the remediation process.

Another powerful oxidant, higher-valent tetraoxy iron, such as, Fe(VI)O4(2-), Fe(V) and Fe(VI), commonly referred to as ferrate (VI), has been explored for a broad portfolio of applications, including a greener oxidant in synthetic organic transformations, a water oxidation catalyst, and an efficient agent for abatement of pollutants in soil, sediment and water. Its use as an oxidant/disinfectant and further utilization of the ensuing iron(III) oxides/hydroxide as coagulants of heavy metals and other contaminants are additional attributes of ferrate for chemical oxidation. The multimodal action is a key advantage of using ferrate (VI) over other commonly used oxidants (e.g., chlorine, chlorine dioxide, permanganate, persulfate, hydrogen peroxide, and ozone).

FIG. 2 is a table that shows the oxidation potential of various oxidants. As can be seen, ferrate iron has a higher oxidation potential than many oxidants.

Historically, a wet oxidation method was utilized for generating a ferrate species. The wet oxidation method is multi-step, and pH dependent, requiring liquid and gas feed/mixing systems. The wet oxidation method involves oxidizing a solution containing trivalent iron, Fe(III), with high alkalinity in the presence of concentrated sodium hydroxide (NaOH) for conversion into ferrate (VI). Since the solution containing ferrate (VI) is degraded rapidly, it is necessary to apply sequestration, washing and drying processes for a more stable product.

Several other efforts have been made to produce sodium ferrate (VI). However, there are still many problems in isolating and obtaining dry product from the corresponding solution, due to the high solubility of Na₂FeO₄ in the NaOH-saturated solution. For example, the production of potassium ferrate (VI) by another wet oxidation method has been studied since 1950. Here, production of ferrate (VI) initially involved obtaining potassium ferrate from the ferric chloride reaction with sodium hypochlorite (NaClO) in the presence of NaOH which in turn effectuates the sequestration of potassium ferrate from the solution by adding potassium hydroxide. The corresponding reactions are:

Fe³⁺+3OH⁻→Fe(OH)₃ (Eq. 1)

2Fe(OH)₃+3NaClO+4NaOH→2Na₂FeO₄+3NaCl+5H₂O (Eq. 2)

Na₂FeO₄+2KOH→K₂FeO₄+2NaOH (Eq. 3)

Other industrial systems for ferrate generation consist of electrical machines of various size that require significant energy and maintenance. These systems typically produce about 5 to 50 ppm ferrate via a batch process. The produced ferrate in solution is often stored in chilled tanks to prevent rapid loss of reactivity.

More recently, Ma et al. (US Publication 2017/0001878) describe the preparation of ferrate based on “nascent state interface activity”. Here, under laboratory conditions (bench-top reaction), they combined an oxidizing agent with iron salt and an alkali solution or particle in water. The aqueous solution was physically mixed and separated by solid-liquid extraction. A ferrate stabilizing material was subsequently added to the resulting liquid which contained ferrate (78 to 98% yield).

The need for support equipment, machinery and energy input to produce ferrate (VI), and its relatively short environmental half-life which requires continuous production and input for sustained treatment processes, are clear disadvantages of utilizing ferrate for in situ environmental applications.

Hence, a safe and efficacious process for generating ferrate (VI) in situ, either alone or in conjunction with other oxidants, offers significant benefits in terms of cost, safety and performance. There is a need in the art for a process of oxidation that targets a full range of contaminants while also fostering biological attenuation of volatile and semi-volatile organic compounds, pesticides and herbicides, and other recalcitrant organic compounds in soils, sediments, clays, rocks, sands, groundwater, and all other environmental media.

### BRIEF DESCRIPTION OF THE DRAWINGS

The features and advantages of the various embodiments will become apparent from the following detailed description in which:

FIG. 1 is a table that outlines the maximum contaminant level (MCE) figures for various chemical contaminants;

FIG. 2 illustrates rankings of oxidation potential of various oxidants including ferrate iron (Fe⁶⁺);

FIG. 3 illustrates rankings of oxidation reduction potential (ORF) for various persulfate activation methods including ferric iron activation;

FIG. 4 illustrates a chemical analysis and elemental composition of an example sample of basic oxygen furnace (BOF) steel slag, according to one embodiment;

FIG. 5 illustrates a chemical composition of an example blend of BOF steel slag fines, according to one embodiment; and

FIG. 6 illustrates the amount of ferrate generated for tests performed for various persulfate activation systems, according to one embodiment.

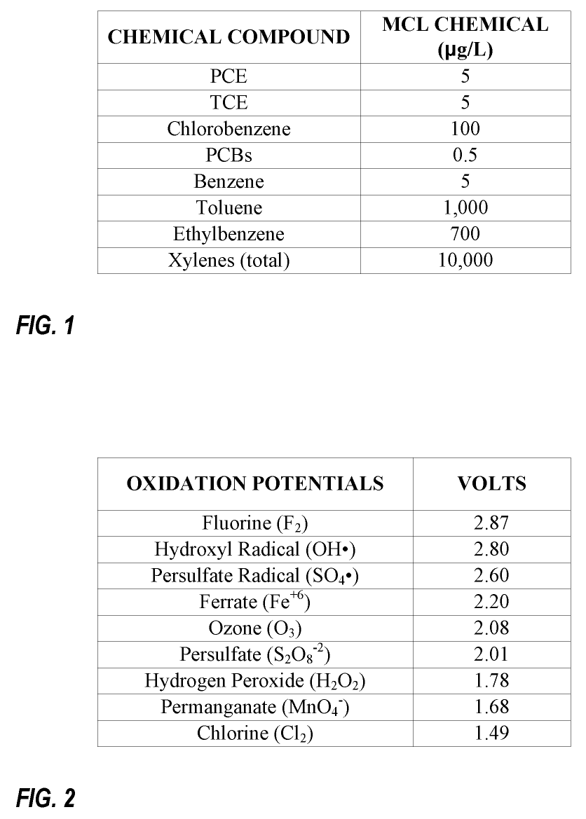

### DETAILED DESCRIPTION

The current remediation process includes utilizing trivalent metals to activate persulfate (S₂O₈). The trivalent metals activate the persulfate in order to chemically oxidize a wide range of targeted contaminants and assist in the eventual (over time) biological attenuation of the contaminants. According to one embodiment, the trivalent metal is ferric iron (Fe³⁺). In alternate embodiments, another trivalent metal ion such as manganese (III) or manganic ion (Mn³⁺) may be used. Persulfate activation with ferric iron requires a lower activation energy than thermal activation, which makes iron activated persulfate a more efficient and rapid way of degrading contaminants. The trivalent metals may be applied, either concurrently or sequentially, with the persulfate.

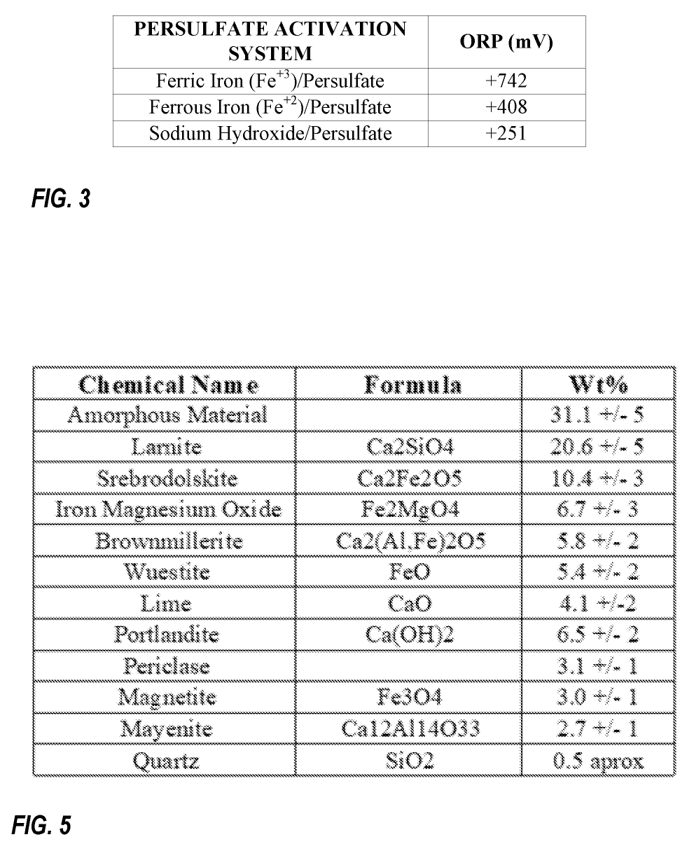

Trivalent metal activated persulfate also has an increased oxidation reduction potential (ORP) over other activation mechanisms. Laboratory studies were performed to test the changes in ORP upon the activation of persulfate with ferric and ferrous iron species, as well as a caustic activator (NaOH). The experiments were performed at room temperature using deionized (DI) water and a 20% activator to persulfate amount. The materials were mixed for approximately 48 hours and the ORP values were measured. FIG. 3 is table that demonstrates the ferric iron/persulfate system was able to establish higher ORP measurements compared to the other systems.

The contaminants that can be effectively treated with this technology include, but are not limited to, various man-made and naturally occurring volatile hydrocarbons including chlorinated hydrocarbons (e.g., volatile, semi-volatile and non-volatile organic compounds), non-chlorinated hydrocarbons, aromatic or polyaromatic ring compounds, brominated compounds, brominated solvents, 1,4-dioxane, insecticides, propellants, explosives (e.g., nitroaniline trinitrotoluene), herbicides, endocrine disrupters (LCDs) and petrochemicals. Examples of volatile organic compounds include chlorinated olefins such as PCE, TCE, cis-1,2-dichioroethane and vinyl chloride. Examples of non-volatile organic compounds include PCBs and dichlorobenzene. Examples of non-chlorinated compounds include total petroleum hydrocarbons (TPHs) such as benzene, toluene, xylene, methyl benzene and ethylbenzene, methyl tert-butyl ether (MTBE), tert-butyl alcohol (TBA) and polyaromatic hydrocarbons (PAHs) such as naphthalene. Anthropogenic chemicals such as perflourinated compounds, pharmaceutical compounds/endocrine disrupters, pesticides, energetics, and perchlorates can also be potentially oxidized by ferrate.

The technology may be used for treatment of various soil and soil-like media including contaminated soils, sediments, clays, rocks, sands and the like (hereinafter collectively referred to as “soils”), contaminated groundwater (i.e., water found underground in cracks and voids of soil, sand and rocks), and aquifers.

In the subsurface, the activated persulfate effectively oxidizes the targeted contaminant(s) by initially oxidizing the contaminants and then promoting facultative biodegradation (biological remediation) of the contaminants. The introduction of sulfate free radicals allows for a long-lived oxidation, which further extends by utilizing the radical residual and stimulating the biological mineralization of the targeted contaminants.

During the chemical oxidation phase, sulfate free radicals attack the aromatic hydrocarbon bonds of organic compound contaminants. A residual of the oxidization process is sulfate (SO₄²⁻) as evidenced by equation 4. Equations 5-7 show the various persulfates (sodium, potassium, and ammonium) being initially broken down into the appropriate element and persulfate prior to the persulfate breaking down into sulfate.

S₂O₈²⁻+2e⁻→2SO₄²⁻ (Eq. 4)

Na₂S₂O₈²⁻→2Na⁺+S₂O₈²⁻+2e⁻→2SO₄²⁻ (Eq. 5)

K₂S₂O₈²⁻→2K⁺+S₂O₈²⁻+2e⁻→2SO₄²⁻ (Eq. 6)

(NH₄⁺)₂S₂O₈²⁻→2NH₄⁺+S₂O₈²⁻+2e⁻→2SO₄²⁻ (Eq. 7)

In addition to direct oxidation, the activation of the persulfate with the trivalent metal (e.g., ferric iron, Fe⁺³) forms sulfate radicals (SO₄.⁻²) as shown in equation 8. This provides free radical reaction mechanisms similar to the hydroxyl radical pathways generated by Fenton's chemistry. The sulfate radicals are used to further oxidize the contaminants. In addition, the oxidation of the ferric iron should theoretically result in the generation of the highly unstable ferrate species of iron (Fe⁶⁺) which can more effectively address the targeted contamination. As noted above, the ferrate iron is a transient species that has elevated oxidation potential compared to other oxidants (refer back to FIG. 2).

S₂O₈⁻+xFe³⁺→xFe^{(4+ to 6+)}+SO₄²⁻+SO₄.²⁻ (Eq. 8)

The chemical oxidation of the contaminants in soil systems is followed by biological attenuation. The biological attenuation utilizes the byproducts of the chemical oxidation process (the sulfate formed and the residual ferric iron). The sulfate ion produced as a consequence of the decomposition of the persulfate allows for the attenuation of the targeted contaminants under sulfate reducing conditions. In addition, the iron present in the subsurface provides terminal electron acceptors for continued biological attenuation. As such, the term “biological attenuation” as used herein refers to degradation of compounds using biological processes and consequently the reduction of substances regarded to be contaminants in the substrate being treated.

After dissolved oxygen has been depleted in the treatment area, sulfate (by-product of the persulfate oxidation) may be used as an electron acceptor for anaerobic biodegradation. This process is termed sulfanogenesis or sulfidogenesis and results in the production of sulfide. Sulfate concentrations may be used as an indicator of anaerobic degradation of fuel compounds. Stoichiometrically, each 1.0 mg/L of sulfate consumed by microbes results in the destruction of approximately 0.21 mg/L of BTEX. Sulfate can play an important role in bioremediation of petroleum products, acting as an electron acceptor in co-metabolic processes as well. The basic reactions of the mineralization of benzene (C₆H₆), toluene (C₇H₈) and xylenes (C₈H₁₀) under sulfate reduction are presented in equations 9-11 respectively.

C₆H₆+3.75SO₄²⁻+3H₂O→0.37H⁺+6HCO₃⁻+2.25HS⁻+2.25H₂S (Eq. 9)

C₇H₈+4.5SO₄²⁻+3H₂O→0.25H⁺+7HCO₃⁻+1.87HS⁻+1.88H₂S (Eq. 10)

C₈H₁₀+5.25SO₄²⁻+3H₂O→0.125H⁺+8HCO₃⁻+2.625HS⁻+2.625H₂S (Eq. 11)

Ferric iron (Fe⁺³) is also used as a terminal electron acceptor during anaerobic biodegradation of many contaminants after sulfate depletion, or sometimes in conjunction therewith. The basic reactions of the mineralization of benzene, toluene and xylenes using ferrous iron are presented in equations 12-14. During this process, ferric iron (Fe⁺³) is reduced to ferrous iron (Fe⁺²), which is soluble in water. Ferrous iron (Fe⁺²) concentrations may then be used as an indicator of anaerobic activity. As an example, stoichiometrically, the degradation of 1 mg/L of BTEX results in the production of approximately 21.8 mg/L of ferrous iron.

C₆H₆+18H₂O+30Fe³⁺→6HCO₃⁻+30Fe²⁺+36H⁺ (Eq. 12)

C₇H₈+21H₂O+36Fe³⁺→7HCO₃⁻+36Fe²⁺+43H⁺ (Eq. 13)

C₈H₁₀+24H₂O+42Fe³⁺→8HCO₃⁻+42Fe²⁺+50H⁺ (Eq. 14)

Ferrous iron formed as a result of the use of the ferric species as a terminal electron acceptor, under the same conditions the residual sulfate is utilized as a terminal electron acceptor by facultative organisms, generates sulfide (2S²⁻). Together, the ferrous iron and the sulfide promote the formation of pyrite (FeS₂) as a remedial byproduct via equation 15. Equation 16 provides a more complete equation identifying where the ferrous iron and the sulfide come from. The reduction of ferric iron to ferrous iron readily supplies electrons to exchange and react with the sulfide. The pyrite is an iron bearing soil mineral with a favorable reductive capacity.

Fe²⁺+2S²⁻→FeS₂ (Eq. 15)

2Fe₂O₃+8SO₄²⁻→4FeS₂+19O₂ (Eq. 16)

Pyrite possesses a finite number of reactive sites that are directly proportional to both its reductive capacity and the rate of decay for the target organics. Pyrite acts as a tertiary treatment mechanism under the reducing conditions of the environment. The reductive capacity of iron bearing soil minerals (like pyrite) initially results in a rapid removal of target organics by minimizing the competition between contaminants and sulfate as a terminal electron acceptor. Preventing these unfavorable interactions with ferric iron provides a continual source for electron exchange resulting in the timely removal of contaminants through pyrite suspension.

The mechanism described herein sidesteps the toxic effects of sulfide and hydrogen sulfide accumulation on the facultative bacteria while providing a means of removing target organics through soil mineral (pyrite) suspension.

Once the reductive capacity of pyrite is met, the bound organic contaminants tend to precipitate out, removing the contaminants rapidly and without the production of daughter products.

The amount of tri-valent metal that should be utilized based on the amount of persulfate that is utilized can be calculated. Referring back to equations 5-7 shows that each persulfate molecule forms two sulfate molecules. We can determine the amount of sulfate that will be generated per amount of a specific persulfate by introducing the molecular weights into the equations.

The molecular weight are as follows: sodium persulfate (238 g), potassium persulfate (270 g), ammonium persulfate (228 g) and sulfate (96 g). Accordingly, 238 g of sodium persulfate, 270 g of potassium persulfate or 228 g of ammonium persulfate yields 192 g (2*96) of sulfate. These weights can be utilized to alternatively state equations 5-7 as:

approximately 1.24 g of sodium persulfate is required to produce 1 g of sulfate (Eq. 5a).

approximately 1.4 g of potassium persulfate is required to produce 1 g of sulfate (Eq. 6a).

approximately 1.19 g of ammonium persulfate is required to produce 1 g of sulfate (Eq. 7a).

Introducing molecular weights into equation 14 we can determine the amount of pyrite generated. The molecular weights are as follows: Fe₂O₃ (160 g), SO₄²⁻ (96 g) and FeS₂ (120 g). Accordingly, 320 g (2*160) of Fe₂O₃ and 768 g (8*96) of SO₄²⁻ creates 480 g (4*120) of FeS₂.

Using molecular weights, we can calculate that 224 g of ferric iron (Fe³⁺) is required to produce the 320 g (2*160) of Fe₂O₃.

Utilizing equations 5a-7a, we can calculate that 952 g of sodium persulfate, 1080 g of potassium persulfate and 912 g of ammonium persulfate are required to produce 768 g of sulfate.

Accordingly, in order to produce the pyrite (e.g., 480 g) one would need to use 224 g of ferric iron and either 952 g of sodium persulfate, 1080 g of potassium persulfate or 912 g of ammonium persulfate. Simplifying the amount of the various persulfates to 100 g results in:

23.53 g of ferric iron required per 100 g of sodium persulfate (23.53%),

20.74 g of ferric iron required per 100 g of potassium persulfate (20.74%) or

24.56 g of ferric iron required per 100 g of ammonium persulfate (24.56%).

The lowest amount of ferric iron required is 20.74% for potassium persulfate and the highest amount of ferric iron required is 24.56% for ammonium persulfate. Accordingly, the amount of ferric iron required is between 20.74% to 24.56% (approximately 20-25%) of the molecular weight of the appropriate persulfate. Accordingly, if a mixture of persulfate and ferric iron included 100 g of persulfate it would include between 20-25 g of ferric iron. The mixture would therefore be between approximately 80% [100 g of persulfateφg of persulfate+25 g of ferric iron)] to 83.3% [100 g of persulfate+100 g of persulfate+20 g of ferric iron)] by weight of persulfate and between approximately 16.7% to 20% by weight of ferric iron.

If it is assumed a 20% range for the values of ferric iron, the amount of ferric iron would be between 18.82%-28.24% for sodium persulfate, 16.59%-24.89% of potassium persulfate or 19.65%-29.47% of ammonium persulfate. Using the lowest and highest amounts of ferric iron from these ranges corresponds to a ferric iron demand between 16.59% and 29.47% (approximately 16-30%) of the molecular weight of the persulfate. Accordingly, a mixture of ferric iron and persulfate would be between approximately 76.9% [100 g of persulfateφg of persulfate+30 g of ferric iron)] to 86.2% [100 g of persulfateφg of persulfate+16 g of ferric iron)] by weight of persulfate and between approximately 13.8% to 23.1% by weight of ferric iron.

As previously noted with regard to equation 8 above, the activation of the persulfate with the trivalent metal (e.g., Fe³⁺) theoretically results in the generation of the highly unstable ferrate species of iron (Fe⁶⁺). Ferrate functions both as an oxidant and subsequent coagulant in the form of Fe(III) (hydro)oxides that can immobilize heavy metals. Ferrate also has one of the highest oxidation potentials of any chemical realistically usable in water and wastewater treatment; Eo=2.200 V under acidic conditions, and Eo=0.72 V under basic conditions. Accordingly, the protonated forms of ferrate are the most reactive, but least stable and shorter lived. As such, it can be very beneficial to generate ferrate in situ for the treatment of groundwater contaminants. The inherent acidity from persulfate reduction (sulfuric acid) can counteract the ferrate chemistry.

Given the high energy required to form ferrate, the use of conventional pH buffering agents (such as magnesium hydroxide) alone are not sufficient to generate ferrate via iron activation (e.g., ferric iron) of persulfate.

Tests were performed to measure the amount of ferrate that was generated for the ferric iron persulfate activation method. The tests were performed by placing persulfate and ferric iron (80:20 ratio) in either deionized water or a phosphate buffer and measuring the amount of ferrate iron generated after 4 hours. The amount generated was basically non-measurable (<1×10⁻⁵M).

Basic oxygen furnace (BOF) steel slag is an industrial biproduct with 100% recycled content. The BOF steel slag is a strongly alkaline semi-crystalline solid with high surface area and rich in iron and other inorganic metals that are highly oxidized having been formed at temperatures ranging from 900 to 1,300 degrees Celsius (1,600 to 2,300 degrees Fahrenheit).

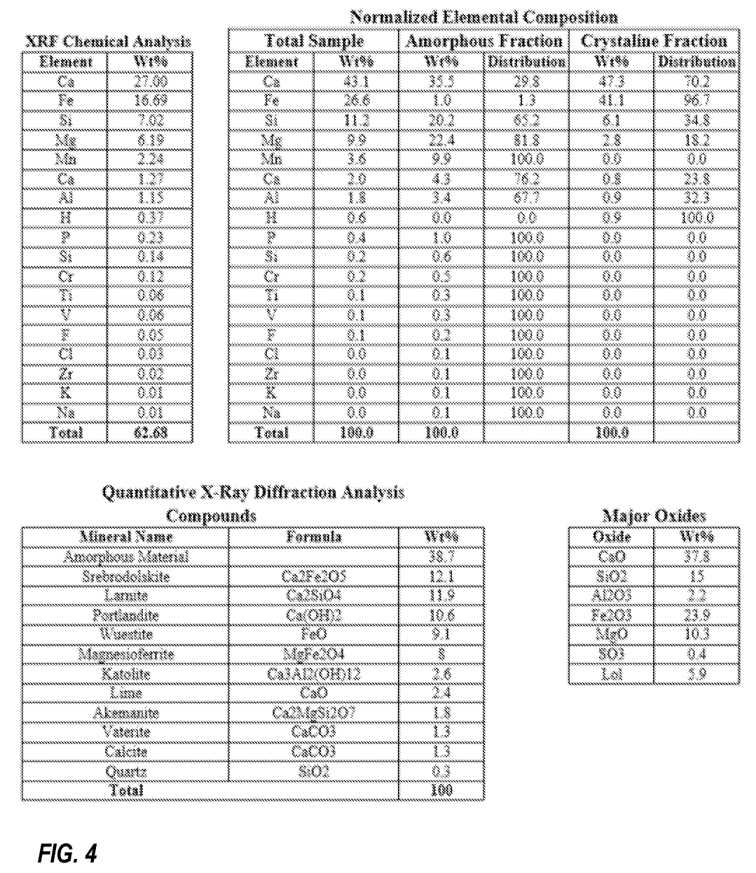

FIG. 4 illustrates a chemical analysis and elemental composition of an example sample of BOF steel slag. The information was gathered using X-ray fluorescence (XRF), inductively coupled plasma atomic emission spectroscopy (ICP-AES) and Reitveld quantification analysis. As illustrated, the BOF steel slag contains (weight basis) 43.1% calcium (Ca) and 9.9% magnesium (Mg) to provide the alkalinity, 26.6% iron (Fe) and 3.6% manganese (Mn) which are oxidized metals, and 11.2% silicon (Si). These minerals were present as both crystalline and amorphous forms. These features can provide the catalysis required to generate ferrate (iron (IV), (V), and/or (VI)) when used as described herein.

The slag can be crushed, screened and/or milled with metallics removal to produce a desired particle size distribution. FIG. 5 illustrates a chemical composition of an example blend of BOF steel slag fines (e.g., <0.297 mm; US No. 50 sieve). The table illustrates how the percentages of the various chemicals may vary based on different parameters associated with, for example, where the BOF slag came from and how it was processed.

The semi-crystalline BOF steel slag fines are a strongly alkaline and highly geochemically active media with high surface area containing significant amounts of iron and other multivalent cationic oxides and silicates that additionally have metals binding capability. As such, BOF steel slag may uniquely act as a supplemental activator of the persulfate, a catalyst to generate ferrate (VI), and a pH buffer to stabilize the ferrate generated—all in situ.

The experiment noted above for ferric iron persulfate activation was performed again with approximately 20% of the ferric iron replaced with basic oxygen furnace (BOF) steel slag fines (e.g., slag fines noted in FIG. 5). The second set of tests included placing persulfate, ferric oxide and BOF slag fines (80:16:4 ratio) in either deionized water or a phosphate buffer and measuring the amount of ferrate iron generated after 4 hours. The amount of ferrate generated (approximately between 2.66 to 2.87×10⁻⁴M) was over 25 times greater than measured without the BOF steel slag. This computes to a relatively large amount (e.g., 3,000 to 4,000 mg/L) of ferrate during the 4-hour reaction time.

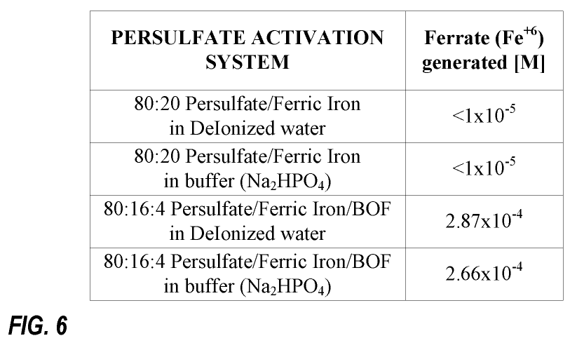

When the BOF slag fines were used to (co)activate persulfate, the process uniquely and unexpectedly generated measurable ferrate in addition to the standard chemistry associated with persulfate oxidation reactions. Hence, in addition to buffering the reactions, BOF steel slag fines provide the catalytic power to generate ferrate that otherwise would not be formed and operates as a ferrate stabilizer. FIG. 6 illustrates the amount of ferrate generated for the ferric iron persulfate activation systems with and without BOF slag.

This process represents a safe, effective, and cost-efficient means of generating ferrate for in situ remedial applications. It can be used alone or in conjunction with other activators such as additional ferric oxide to enable secondary bioremediation processes. All materials can be pre-mixed and packaged as dry powder that can be easily and safely introduced to the subsurface environment via direct mixing, hydraulic fracturing, pneumatic fracturing, and direct push injection of slurries. Other application processes are hereby incorporated. Ferrate will be continuously generated in situ to support extended oxidation of persistent compounds, provided that persulfate is maintained with iron as an activator. Thereafter, the residual iron and sulfate will support bioremediation processes to manage partially oxidized compounds and residual contaminants that continually desorb from the matrix over time.

Ferrate may be generated in situ when persulfate is activated with a combination of ferric iron (trivalent iron) and BOF steel slag fines as noted above. The ratio of ferric iron to BOF steel slag fines may be the 80:20 ratio noted in the test above but is in no way limited thereto. For example, according to one embodiment the activator may simply be BOF steel slag fines as they contain a significant amount of iron. The BOF steel slag may be blended with other iron species (e.g., ferric iron). The in situ activation will produce multiple reactive oxidant species (ROS) such as hydrogen peroxide (H₂O₂), superoxide (O2.), sulfate radicals, hydroxyl radicals (OH.) and—uniquely—ferrate species including Fe IV, V and VI. These ROS will destroy organic compounds and can oxidize inorganics.

There are significant differences between this embodiment and other known processes for making ferrate, such as those discussed in the background. These include: i) the ability to generate stabilized ferrate in situ via the injection of a reagent blend that, when combined with persulfate-based reactive species, provide an expanded suite of degradative abilities while simultaneously supporting enhanced biodegradation processes using residual sulfate and iron as alternative electron acceptors; ii) the ability to generate ferrate in situ in a single step process; and iii) the use of BOF steel slag avoids the need for additional pH buffers and ferrate stabilizers.

Persons skilled in the art will appreciate that the concept, upon which this disclosure is based, may readily be utilized as a basis for the designing of other structures, methods, and systems for carrying out the several purposes of the present invention. It is important, therefore, that the claims be regarded as including such equivalent constructions insofar as they do not depart from the spirit and scope of the present invention.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Although the invention has been illustrated by reference to specific embodiments, it will be apparent that the invention is not limited thereto as various changes and modifications may be made thereto without departing from the scope. Reference to “one embodiment” or “an embodiment” means that a particular feature, structure or characteristic described therein is included in at least one embodiment. Thus, the appearances of the phrase “in one embodiment” or “in an embodiment” appearing in various places throughout the specification are not necessarily all referring to the same embodiment.

The various embodiments are intended to be protected broadly within the spirit and scope of the appended claims.

1. A method for chemical oxidation followed by a biological attenuation process of an environmental system containing one or more contaminants, the method comprising:
introducing a persulfate, basic oxygen furnace (BOF) steel slag, and one or more iron species into the environmental system, wherein the persulfate is activated, and ferrate is generated in order to chemically oxidize the one or more contaminants.

2. The method of claim 1, wherein amount of the persulfate is selected to chemically oxidize the one or more contaminants and amount of the one or more iron species and BOF steel slag is sufficient to generate ferrate and that at conclusion of the chemical oxidation sufficient residual sulfate and sufficient residual iron species and sulfate remain such that:
i) naturally occurring facultative cultures utilize the residual sulfate and the residual iron species as terminal electron acceptors to promote the biological attenuation process of the one or more contaminants; and
ii) the residual sulfate and the residual iron species mitigate formation and accumulation of hydrogen sulfide which is a toxin to the facultative cultures.

3. The method of claim 1, wherein the introducing persulfate, BOF steel slag and one or more iron species includes introducing the persulfate, BOF steel slag and one or more iron species via temporary or permanent wells or injection locations/manifolds.

4. The method of claim 1, wherein the introducing the persulfate, BOF steel slag and one or more iron species includes introducing the persulfate, BOF steel slag and one or more iron species via gravity feeding, induced gas stream, a pump, or a combination thereof.

5. The method of claim 1, wherein the introducing persulfate, BOF steel slag and one or more iron species includes introducing the persulfate, BOF steel slag and one or more iron species under pressure in either a gas and/or liquid stream.

6. The method of claim 1, wherein the introducing persulfate, BOF steel slag and one or more iron species includes introducing the persulfate, BOF steel slag and one or more iron species via physical injection, direct mixing, or any other means of adding reagent in situ and/or on site for soil, sediment and groundwater environments.

7. The method of claim 1, wherein the persulfate, the BOF steel slag and the one or more iron species are combined before introduction into the environmental system.

8. The method of claim 1, wherein the persulfate, the BOF steel slag and the one or more iron species are introduced into the environmental system sequentially.

9. The method of claim 1, wherein the one or more iron species includes ferric iron.

10. The method of claim 1, wherein the persulfate is sodium persulfate.

11. The method of claim 1, wherein the one or more contaminants includes organic and/or inorganic constituents.

12. A method for chemical oxidation followed by a biological attenuation process of an environmental system containing one or more contaminants, the method comprising:
introducing a persulfate and a basic oxygen furnace (BOF) steel slag mixture into the environmental system, wherein the persulfate is activated by the BOF steel slag mixture and ferrate is generated in order to chemically oxidize the one or more contaminants.

13. The method of claim 12, wherein amount of the persulfate is selected to chemically oxidize the one or more contaminants and amount of the BOF steel slag mixture is sufficient to generate ferrate and that at conclusion of the chemical oxidation sufficient residual sulfate and sufficient residual iron species and sulfate remain such that:
i) naturally occurring facultative cultures utilize the residual sulfate and the residual iron species as terminal electron acceptors to promote the biological attenuation process of the one or more contaminants; and
ii) the residual sulfate and the residual iron species mitigate formation and accumulation of hydrogen sulfide which is a toxin to the facultative cultures.

14. The method of claim 12, wherein the persulfate and the BOF steel slag mixture are combined before introduction into the environmental system.

15. The method of claim 12, wherein the persulfate and the BOF steel slag mixture are introduced into the environmental system sequentially.

16. The method of claim 12, wherein the BOF steel slag mixture includes one or more iron species.

17. A method for chemical oxidation followed by a biological attenuation process of an environmental system containing one or more contaminants, the method comprising:
injecting persulfate and an activator mixture into the environmental system, wherein the activator mixture includes basic oxygen furnace (BOF) steel slag and ferric iron, wherein
amount of the persulfate is selected to chemically oxidize the one or more contaminants when activated; and
amount of the activator mixture is sufficient to activate the persulfate, generate ferrate and provide sufficient residual sulfate and sufficient residual iron species and sulfate at conclusion of the chemical oxidation such that:
i) naturally occurring facultative cultures utilize the residual sulfate and the residual iron species as terminal electron acceptors to promote the biological attenuation process of the one or more contaminants; and
ii) the residual sulfate and the residual iron species mitigate formation and accumulation of hydrogen sulfide which is a toxin to the facultative cultures.

18. The method of claim 17, wherein the persulfate and the activator mixture are combined before injection into the environmental system.

19. The method of claim 17, wherein the persulfate and the activator mixture are injected into the environmental system sequentially.

20. The method of claim 17, wherein the activator mixture includes approximately 80 percent ferric iron and approximately 20 percent BOF steel slag.
